(19) United States
(12) Patent Application Publication
(10) Pub. No.: US 2019/0122235 A1
(43) Pub. Date: Apr. 25, 2019

(54) JOINT OPTIMIZATION FOR SOCIAL CONTENT DELIVERY OR DISSEMINATION

(71) Applicant: UNIVERSITY OF MARYLAND, COLLEGE PARK, College Park, MD (US)

(72) Inventors: John S. BARAS, Potomac, MD (US); Xiangnan WENG, Greenbelt, MD (US)

(21) Appl. No.: 16/094,633

(22) PCT Filed: May 3, 2017
(86) PCT No.: PCT/US2017/030906

§ 371 Date: Oct. 18, 2018

Related U.S. Application Data
(60) Provisional application No. 62/331,052, filed on May 3, 2016.
(60) Provisional application No. 62/337,164, filed on May 16, 2016.
(60) Provisional application No. 62/345,551, filed on Jun. 3, 2016.

(51) Int. Cl. G06Q 30/02; H04L 29/08; G06F 9/54

(52) U.S. Cl. CPC G06Q 30/0202; G06Q 30/0231; H04L 67/22; G06Q 50/01; G06F 9/542; G06Q 30/0235; H04L 67/04

(57) ABSTRACT

Various communication systems may benefit from optimized delivery or dissemination of information. For example, various wireless networks including heterogeneous wireless may benefit from joint optimization for social content delivery or dissemination over such networks. A method can include selecting content to deliver according to user reward values given wireless capacity constraints. The method can also include delivering the content to a plurality of users via a wireless network comprising different transmission modes.

### CROSS-REFERENCE TO RELATED APPLICATIONS

This application is related as a non-provisional to, and claims the benefit and priority of, U.S. Provisional Patent Application No. 62/331,052, filed May 3, 2016, U.S. Provisional Patent Application No. 62/337,164 filed May 16, 2016, and U.S. Provisional Patent Application No. 62/345,551 filed Jun. 3, 2016, the entirety of each of these three applications is hereby incorporated herein by reference.

### GOVERNMENT LICENSE RIGHTS

This invention was made with government support under CNS1035655 awarded by NSF and FA875015C0038 awarded by DARPA-AFRL. The government has certain rights in the invention.

### BACKGROUND

### Field

Various communication systems may benefit from optimized delivery or dissemination of information. For example, various wireless networks including heterogeneous wireless may benefit from joint optimization for social content delivery or dissemination over such networks.

### Description of the Related Art

Social networks, which enable information sharing among users, have long existed on the Internet in various forms. However, it is not until the past decade that they experienced huge commercial and social success. Facebook, Twitter, YouTube, along with innumerable social networks, greatly facilitate information exchange for users all across the world. Their successes rely heavily, if not solely, on content consumptions and engagements from the users.

Instead of requiring users actively seek and/or disseminate content, modem social networks moved to take the active role in ‘pushing’ content to users, utilizing recommendations based on user profiles, including but not limited to social associations, engagement history, and the like. On one hand, social network providers are collecting more data about users than ever (‘big data’), to deliver highly relevant contents for users to consume; on the other hand, users are more willing to share data with their trusted social network providers, in return for better experience. Therefore, researchers in this area are working diligently to maximize user experience by delivering high quality predictions of how much reward the social networks obtained when a user consumed a specific content, based on numerous features of both users and contents. Metrics of rewards are different for different systems. For example, for ads systems, one possible reward metric is the revenue earned from displaying ads to users; for video subscription systems, the time users spent on the video.

In the real world, such rewards are hardly static since they evolve with time, though the dynamics governing such evolutions remain an open question. Intuitively, just like any contagious disease, the evolutions are ‘viral’, in that they require certain forms of interactions between the users, be it ‘share’, ‘like’, rate or comment. Particularly, researchers have already confirmed the effectiveness of friend's recommendations compared to those generated by the algorithm. In fact, as the commercial success of Facebook demonstrates, users are more vulnerable to influence and consume contents (even ads) that are disseminated by actual human users, especially by their friends. Modern social networks significantly reduce the degree of separations between users and ‘infection’ time using attention-grabbing mobile notifications, which in turn makes these interactions more pervasive.

Most (if not all) social networks are reporting that their users are dominantly mobile, namely that a majority of the users access social networks mainly on their mobile devices. Unfortunately, most of the social network (mobile) applications were designed from the root concept of wired connections, assuming unlimited capacity, and almost no latency or failures in transmission. Unlike wired connections, wireless networks are limited by insufficient radio frequency resource and ever changing channel characteristics. As multimedia contents dominate contents consumed in social network applications, the disparity between the capacity constraints of wireless networks and the assumptions of guaranteed delivery of contents, results in poor mobile experience and loss of user engagements, or ultimately users themselves.

Even with new generations of access technology (such as LTE-Advanced and beyond), users are still unable to fetch their contents when the number of active users increases, because the wireless network becomes congested as it approaches its capacity limits and quality of service degrades drastically. Hence, there may be a need to provide services in these scenarios so that users are still able to consume contents, even though these contents might not be the best contents recommended from the perspective of the social network applications.

Existing solutions failed to utilize the social nature of content consumption or the broadcast nature of wireless networks. In light of the preliminary research and industrial observations of social network applications, it can be seen that users exhibit patterns of temporal, spatial and social correlations: they are extremely likely to consume the same contents, though not at the exact same time.

### SUMMARY

According to certain embodiments, a method can include selecting content to deliver according to user reward values given wireless capacity constraints. The method can also include delivering the content to a plurality of users via a wireless network comprising different transmission modes.

In certain embodiments, an apparatus can include means for selecting content to deliver according to user reward values given wireless capacity constraints. The apparatus can also include means for delivering the content to a plurality of users via a wireless network comprising different transmission modes.

An apparatus, according to certain embodiments, can include at least one processor and at least one memory including computer program code. The at least one memory and the computer program code can be configured to, with the at least one processor, cause the apparatus at least to select content to deliver according to user reward values given wireless capacity constraints. The at least one memory and the computer program code can also be configured to, with the at least one processor, cause the apparatus at least to deliver the content to a plurality of users via a wireless network comprising different transmission modes.

A non-transitory computer-readable medium, in certain embodiments, can be encoded with instructions that, when executed in hardware, perform a process. The process can include selecting content to deliver according to user reward values given wireless capacity constraints. The process can also include delivering the content to a plurality of users via a wireless network comprising different transmission modes.

### BRIEF DESCRIPTION OF THE DRAWINGS

For proper understanding of the invention, reference should be made to the accompanying drawings, wherein:

FIG. 1 illustrates a centralized system, according to certain embodiments of the present invention.

FIG. 2 illustrates influence links according to certain embodiments.

FIG. 3 illustrates a method according to certain embodiments of the present invention.

FIG. 4 illustrates a system according to certain embodiments of the invention.

### DETAILED DESCRIPTION

As mentioned above, users may exhibit patterns of temporal, spatial and social correlations: they are extremely likely to consume the same contents, though not at the exact same time. Certain embodiments of the present invention, therefore, multicast and pre-cache contents to groups of users to reduce redundant transmissions.

Under congested circumstances, the system can deliver contents that maximize overall user experience across the system, but not necessarily optimal for each individual user. In other words, contents can be delivered in a collectively optimal way when the wireless networks are congested. This approach may require information from both social and wireless networks to jointly optimize system decisions.

Preliminary work has been done concerning the joint user experience optimization incorporating social and wireless networks. For example, a joint optimization approach for a single base station can outperform existing layered solutions, especially when the wireless resource is insufficient. The scheduling framework can be extended to scenarios with multiple base stations, by introducing a scalable two-phase scheduling including each base station making its own decisions and the system eliminating redundancy.

Certain embodiments of the present invention can take into account the dynamics of social networks. Reward values can be time-variant, based on the interactions of users. For example, contents may only become more rewarding and viral after certain users, such as celebrities or other public figures consume and spread them. Content dissemination or cascade in social networks generally follows a diffusion process. The cascades may be predictable with high precision based on user profiles. Network diffusion parameters can be inferred for a continuous time diffusion model. However, the models used at a social network layer may need to consider the facts that mobile delivery can be the bottleneck of social content dissemination.

Certain embodiments of the present invention address the content dissemination issue with respect to capacity constraints in a system with centralized wireless infrastructure. Certain embodiments, for example, can determine what contents to deliver to which users and how to transmit them.

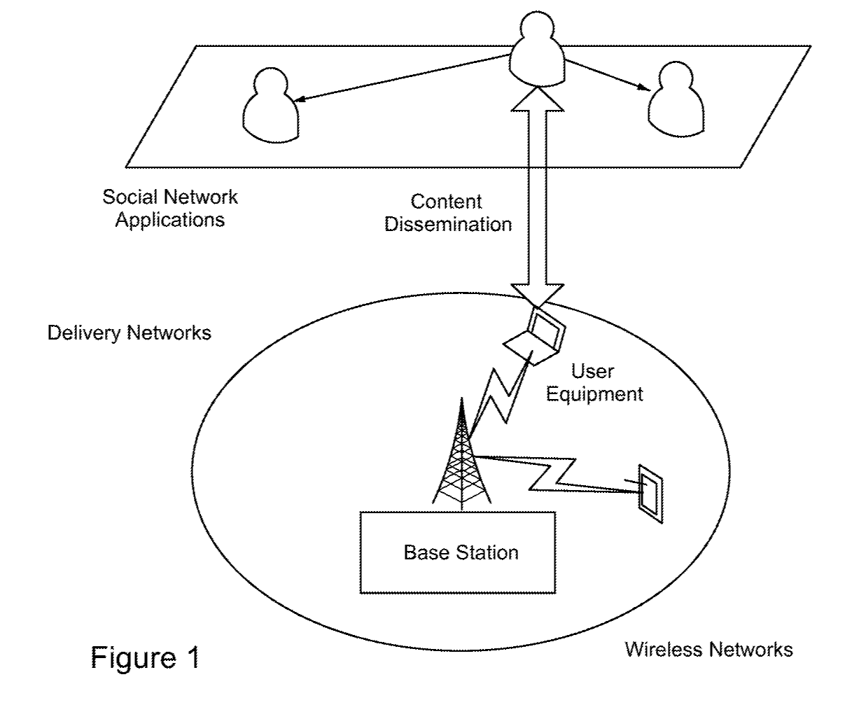

Certain embodiments of the present invention may relate to a centralized system that both selects contents to deliver according to user rewards given wireless capacity constraints and delivers the contents to users via a wireless network comprising different transmission modes. FIG. 1 illustrates a centralized system, according to certain embodiments of the present invention.

Channel information of all users for all base stations can be known to the system. The bandwidth of the wired connections among the base stations and between base stations and content server(s) may be sufficient that the base station could access contents as if they were stored locally. This assumption may be valid in practice because base stations may be connected via fiber optic cables. Trivially, with developments of memory chips, the storage on user devices may be sufficiently large to pre-cache all the contents scheduled for delivery.

As an example, a slotted single base station scenario can be considered with K multicast modes and slot length T. Transmitting any content can be done within one scheduling slot to avoid management complexity of multicast groups. The system may be configured to maximize overall user rewards of the system subject to capacity constraints.

Reward for transmitting content j to user i can be time-variant. Only contents with positive reward value would be scheduled for transmission.

Time-variance of reward can come from the following two aspects. First, social dynamics can be one aspect. Users may become more or less interested in a content than before, due to other users. Specifically users may become more interested due to the behaviors or interactions of other users. Second, information revelation can be a second aspect. After gathering sufficient information regarding users or their peer, the social networks may adjust previous predictions.

Time-variance can be modelled based on social dynamics. This can be seen, for example, in the area of content dissemination with the help of influence graphs.

At a social layer, for a given content without delivery delay, the continuous-time reward change can be modeled as an activation process: the reward for user i to consume the content at time slot t can be dependent on reward value and its binary activation state.

The activation process can be based on directed graph G=(V, E). Binary activation state of user u can be dependent on previous activation states of influencer set Iu-er. Conversely, the influencee set can be Iu-ee.

For generality, the influencer/influencee set may not be confined to include only the explicit neighbors of the user. Due to system complexity, for example, the influence propagation can be usually calculated based on a sparse set of users. For simplicity, it can be assumed that once users are activated, they will stay activated.

A diffusion parameter can reflect the influence rate of the influence between the influencer and the influence. The larger, the more quickly the influence is activated due to the influencer. A value of zero can indicate that a given user has no influence over the target user.

The state transition process can be essentially a Markov Chain with a calculable transition rate and transition probability. Modern social network applications significantly increase the influence rate in a selective way, resulting in much shorter activation time for certain social connections. This is due to the facts that notifications on mobile devices may be more visible to the users, and at the same time users may generally be more attentive when they use mobile devices.

Please see U.S. Provisional Patent Application 62/345,551, for detailed mathematical explanations of this model. For simplicity, such details are omitted from the present discussion but are incorporated by reference in their entirety.

There can be at least two approaches to scheduling transmissions. Traditional systems use an on-demand system. For example, traditional systems schedule transmissions only after users are activated, hoping to achieve low latency for each individual transmission. Such goal is extremely hard to achieve without sacrificing overall system performance, especially when the wireless capacity is insufficient.

Another approach is to pre-cache. In this case, the system can transmit content to the users before the users request the content. This approach makes it possible for some users to enjoy no delivery delay, if not for all users, provided that the delivery happens before user activation happens.

The system is not obliged to provide a universal delivery guarantee for all users any time. Thus, certain users at certain social network activation states could receive different quality of service from other users. Moreover, with multicast available, it may be possible to eliminate the delivery delay for a group of users at the same time.

The system can rely on a Monte Carlo Estimation based on a simple detector. Moreover, the more initial activated users and/or the longer the dissemination horizon is, the more precise the Monte Carlo Estimation can be.

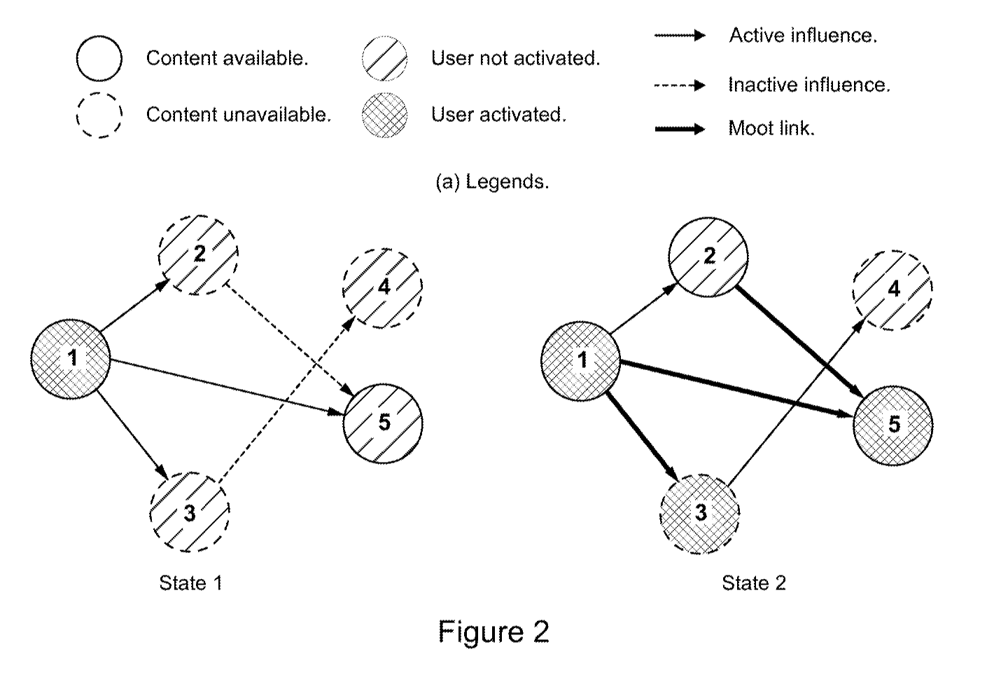

FIG. 2 illustrates influence links according to certain embodiments. As shown in FIG. 2, in state 1 user 1 and user 5 have the contents available, and user 1 is activated. All the influence links originating from user 1 are active, but other links are inactive, because their influencers are not activated.

State 2 illustrates a possible evolution from state 1. In state 2, user 5 is activated and user 2 has content delivered. There cannot be a reward claimed for user 3, because the content is not yet available. User 4 is not under any active influence, because its influencer, user 3, has not yet acquired the content. Any link with both nodes activated can be considered moot.

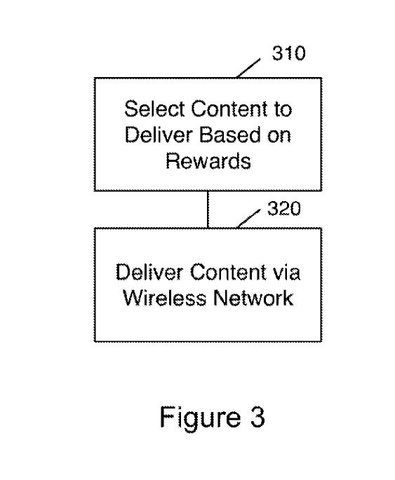

FIG. 3 illustrates a method according to certain embodiments of the present invention. As shown in FIG. 3, a method can include, at 310, selecting content to deliver according to user reward values given wireless capacity constraints.

The user reward values can be time-variant, based on interactions of users. The reward can be a reward for delivering content to a user. The value of the reward can be earned upon successfully delivery of the entire content. Partial or repeated delivery may not earn any additional reward. The reward information may be obtained from social network applications using big data techniques.

The user reward values can include a predicted look-ahead reward for delivering content to a respective user at an identified time slot. Moreover, the user reward values can include an additional reward if a respective user is activated for the content an identified time slot. The additional reward is weighted by a weighting factor. If the weighting factor is zero, then the system may in essence function as a pure push system.

A reward matrix may be sparse, given that users may have diverse interests toward different content, and given technical challenges in assembling adequate data to provide an accurate and comprehensive prediction. Nevertheless, in the sparse reward matrix, there is no need to distinguish between unknown reward and lack of interest: both may receive a zero reward value.

The selecting at 310 can occur repeatedly for each time slot, looking ahead to the next time slot.

The method can also include, at 320, delivering the content to a plurality of users via a wireless network comprising different transmission modes. The delivering can include multicasting the content to the plurality of the users. Other modes of communication in the wireless network may include, for example, unicasting and broadcasting.

The content can be provided on-demand. Alternatively, the content can be provided to a user before that user specifically requested it, which can refer to a situation in which the content is provided for pre-caching by the users.

The content can be delivered in a variety of ways. For example, the content can be delivered by a base station. In certain embodiments, there may be both a macro base station and pico base stations. In such cases, there may be coordination by the radio access network to optimize delivery of the content over the macro base station and/or pico base stations. The system may be configured to avoid duplicating transmissions between the macro and pico base stations.

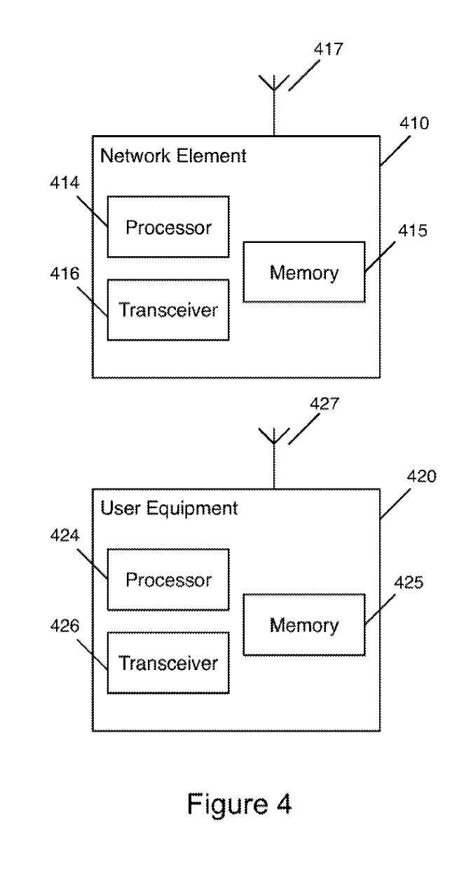

FIG. 4 illustrates a system according to certain embodiments of the invention. It should be understood that each block of the flowchart of FIG. 3 may be implemented by various means or their combinations, such as hardware, software, firmware, one or more processors and/or circuitry. In one embodiment, a system may include several devices, such as, for example, network element 410 and user equipment (UE) or user device 420. The system may include more than one UE 420 and more than one network element 410, although only one of each is shown for the purposes of illustration. A network element can be an access point, a base station, an eNode B (eNB), or any other network element, such as a macro base station or a pico base station.

Each of these devices may include at least one processor or control unit or module, respectively indicated as 414 and 424. At least one memory may be provided in each device, and indicated as 415 and 425, respectively. The memory may include computer program instructions or computer code contained therein, for example for carrying out the embodiments described above. One or more transceiver 416 and 426 may be provided, and each device may also include an antenna, respectively illustrated as 417 and 427. Although only one antenna each is shown, many antennas and multiple antenna elements may be provided to each of the devices. Other configurations of these devices, for example, may be provided. For example, network element 410 and UE 420 may be additionally configured for wired communication, in addition to wireless communication, and in such a case antennas 417 and 427 may illustrate any form of communication hardware, without being limited to merely an antenna.

Transceivers 416 and 426 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 420 may be a mobile station (MS) such as a mobile phone or smart phone or multimedia device, a computer, such as a tablet, provided with wireless communication capabilities, personal data or digital assistant (PDA) provided with wireless communication capabilities, vehicle, portable media player, digital camera, pocket video camera, navigation unit provided with wireless communication capabilities or any combinations thereof. The user device or user equipment 420 may be a sensor or smart meter, or other device that may usually be configured for a single location.

In an exemplifying embodiment, an apparatus, such as a node or user device, may include means for carrying out embodiments described above in relation to FIG. 3.

Processors 414 and 424 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof. The term circuitry may refer to one or more electric or electronic circuits. The term processor may refer to circuitry, such as logic circuitry, that responds to and processes instructions that drive a computer.

For firmware or software, the implementation may include modules or units of at least one chip set (e.g., procedures, functions, and so on). Memories 415 and 425 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 410 and/or UE 420, to perform any of the processes described above (see, for example, FIG. 3). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 4 illustrates a system including a network element 410 and a UE 420, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Similarly, the social network servers may be configured like network element 410. Other network devices may also be similarly configured.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
selecting content to deliver according to user reward values given wireless capacity constraints; and
delivering the content to a plurality of users via a wireless network comprising different transmission modes.

2. The method of claim 1, wherein the delivering comprising multicasting the content to the plurality of the users.

3. The method of claim 1, wherein the content is provided for pre-caching by the users.

4. The method of claim 1, wherein the user reward values are time-variant, based on interactions of users.

5. The method of claim 1, wherein the user reward values comprise a predicted look-ahead reward for delivering content to a respective user at an identified time slot.

6. The method of claim 1, wherein the user reward values comprise an additional reward if a respective user is activated for the content an identified time slot.

7. The method of claim 6, wherein the additional reward is weighted by a weighting factor.

8. An apparatus, comprising:
means for selecting content to deliver according to user reward values given wireless capacity constraints; and
means for delivering the content to a plurality of users via a wireless network comprising different transmission modes.

9. The apparatus of claim 8, wherein the means for delivering comprises means for multicasting the content to the plurality of the users.

10. The apparatus of claim 8, wherein the content is provided for pre-caching by the users.

11. The apparatus of claim 8, wherein the user reward values are time-variant, based on interactions of users.

12. The apparatus of claim 8, wherein the user reward values comprise a predicted look-ahead reward for delivering content to a respective user at an identified time slot.

13. The apparatus of claim 8, wherein the user reward values comprise an additional reward if a respective user is activated for the content an identified time slot.

14. The apparatus of claim 13, wherein the additional reward is weighted by a weighting factor.

15. An apparatus, comprising:
at least one processor; and
at least one memory including computer program code,
wherein the at least one memory and the computer program code are configured to, with the at least one processor, cause the apparatus at least to
select content to deliver according to user reward values given wireless capacity constraints; and
deliver the content to a plurality of users via a wireless network comprising different transmission modes.

16. The apparatus of claim 15, wherein the at least one memory and the computer program code are configured to, with the at least one processor, cause the apparatus at least to multicast the content to the plurality of the users.

17. The apparatus of claim 15, wherein the content is provided for pre-caching by the users.

18. The apparatus of claim 15, wherein the user reward values are time-variant, based on interactions of users.

19. The apparatus of claim 15, wherein the user reward values comprise a predicted look-ahead reward for delivering content to a respective user at an identified time slot.

20. The apparatus of claim 15, wherein the user reward values comprise an additional reward if a respective user is activated for the content an identified time slot.

21. The apparatus of claim 20, wherein the additional reward is weighted by a weighting factor.

22. A non-transitory computer-readable medium encoded with instructions that, when executed in hardware, perform a process, the process comprising the method according to claim 1.
